(19) United States
(12) Patent Application Publication
(10) Pub. No.: US 2014/0136358 A1
(43) Pub. Date: May 15, 2014

(54) SUPPLIER QUANTITY SELECTION

(71) Applicant: HEWLETT-PACKARD DEVELOPMENT COMPANY, L.P., Houston, TX (US)

(72) Inventors: Kemal Guler, San Jose, CA (US); Alper Sen, Ankara (TR); Hande Yaman, Ankara (TR); Evren Korpeoglu, Palo Alto, CA (US); Ece Demirci, Ankara (TR)

(73) Assignee: Hewlett-Packard Development Company, L.P., Houston, TX (US)

(21) Appl. No.: 13/676,957

(22) Filed: Nov. 14, 2012

(51) Int. Cl. G06Q 30/06

(52) U.S. Cl. CPC G06Q 30/0611
USPC 705/26.4

(57) ABSTRACT

According to an example, a method for supplier quantity selection may include receiving a plurality of supplier offers for one or more items to be procured by a manufacturer, and determining whether the supplier offers include price uncertainty and a most favored customer (MFC) clause. Based on the determination that the supplier offers include price uncertainty and the MFC clause, the method may include evaluating the supplier offers by analyzing the price uncertainty and the MFC clause using a stochastic multi-stage model. The method may further include determining, by a processor, an allocation of all or part of each of the supplier offers to minimize purchase price of the one or more items based on the evaluation of the supplier offers.

### BACKGROUND

In a supply and manufacturing environment, suppliers may offer all or a selection of items that a manufacturer may need to procure over a planning horizon that may include multiple periods. For example, a manufacturer may need to procure large volumes of items (e.g., key components) for manufacturing products over a planning horizon (e.g., a quarter) that may include multiple periods (e.g., months). Typically, contractual agreements between suppliers and manufacturers may include aspects related to base pricing for items, possible discounts, most favored customer (MFC) clauses, price uncertainty, etc. A MFC clause may include, for example, a contractual arrangement between a supplier and a manufacturer that guarantees the manufacturer the best price the supplier gives to any other manufacturer. Price uncertainty may refer to the uncertainty of a supplier's price for an item, for example, with respect to the manufacturers subject to MFC clauses. These aspects may be relevant to the accuracy of contractual agreements between suppliers and manufacturers.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a supplier quantity selection apparatus, according to an example of the present disclosure;

FIG. 2 illustrates price reduction probability for the supplier quantity selection apparatus, according to an example of the present disclosure;

FIG. 3 illustrates a method for supplier quantity selection, according to an example of the present disclosure; and

FIG. 4 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a supply and manufacturing environment, typically, supplier production costs for items that are needed by manufacturers may exhibit economies of scale and scope. For example, unit costs for items may reduce with higher volume of a particular item, or a group of items. Suppliers may express such economies of scale and scope by offering discounts to a manufacturer. Discounts may include, for example, price reduction on one item, or a group of items, and/or price reduction based on total available market, volume, spending, conditions on items individually, or a set of items, and/or specific periods. Discounts may also account for disjunctions (i.e., where a discount is not valid with other discounts).

Suppliers may offer all or a selection of items that a manufacturer may need to procure over a planning horizon that may include multiple periods. In order for manufacturers to choose one or more supplier offers, the supplier offers may be collected prior to the start of the planning horizon. The choice of one or more supplier offers may take into account aspects such as pricing, discounts, limits on the amount of capacity that can be allocated by a supplier to a manufacturer, and/or whether inventory may be carried over from one period to the other.

The supplier offers that are chosen may be formalized into contractual agreements that may include aspects related, for example, to base pricing for items, possible discounts, MFC clauses, price uncertainty, etc. MFC clauses may include, for example, contractual arrangements between a supplier and a manufacturer that guarantee the manufacturer the best price the supplier gives to any other manufacturer. Due to price uncertainty, MFC customers may benefit from price drops in items. A MFC clause may however be based on a minimum purchase volume for a set of items over a specified time period.

For example, a MFC clause may indicate that a supplier-A represents and warrants to a manufacturer-B the product prices or license fees offered to manufacturer-B under a contractual agreement are no less favorable than the product prices or license fees offered to any other manufacturer purchasing or licensing similar quantities for similar items. The MFC clause may further state that in the event supplier-A offers more favorable product prices or license fees to any other manufacturer, supplier-A will promptly notify manufacturer-B of such event and offer such more favorable product prices or license fees to manufacturer-B commencing upon the date such more favorable product prices or license fees were offered to the other party. Thus the MFC clause in a contract may bound a supplier to guarantee to the manufacturer the best price the supplier gives to any other manufacturer for similar items.

However, manufacturers typically do not commit to MFC clauses for the benefit of suppliers. Instead, manufacturers may make item purchase decisions such as “here-and-now” or “wait-and-see” decisions. For the here-and-now decision, a manufacturer may choose one or more suppliers from a list of suppliers that will be used for each item, and/or based on a volume to be purchased from each supplier for each item in a first period. For the wait-and-see decision, a manufacturer may choose one or more suppliers from a list of suppliers that will be used for each item, and/or based on a volume to be purchased from each supplier for each period contingent on new item prices.

The foregoing aspects related to suppliers and manufacturers are examples of aspects that may be considered in a process of evaluating contractual agreements between suppliers and manufacturers. However, evaluating aspects such as uncertainties resolved over a contracting period can be challenging. For example, uncertainties resolved over a contracting period may need to be evaluated to accurately evaluate MFC clauses in contractual agreements.

According to an example, a supplier quantity selection apparatus and a method for supplier quantity selection are described and provide a stochastic multi-stage solution to the evaluation and allocation of complex supplier offers that include MFC clauses. The apparatus and method provide for formal analysis of the implications of MFC clauses in supplier offers for the optimal allocation of supply contracts, and for formal treatment of the trade-offs in supplier selection. For example, the apparatus and method provide for formal analyses of the implications of MFC clauses in supplier offers by taking both price uncertainty and MFC terms explicitly into account. The apparatus and method may be used to determine how a company (e.g., a manufacturer) should allocate the company's spend resources to multiple vendors (e.g., suppliers) that offer various discount offers and MFC benefits that are contingent on various conditions.

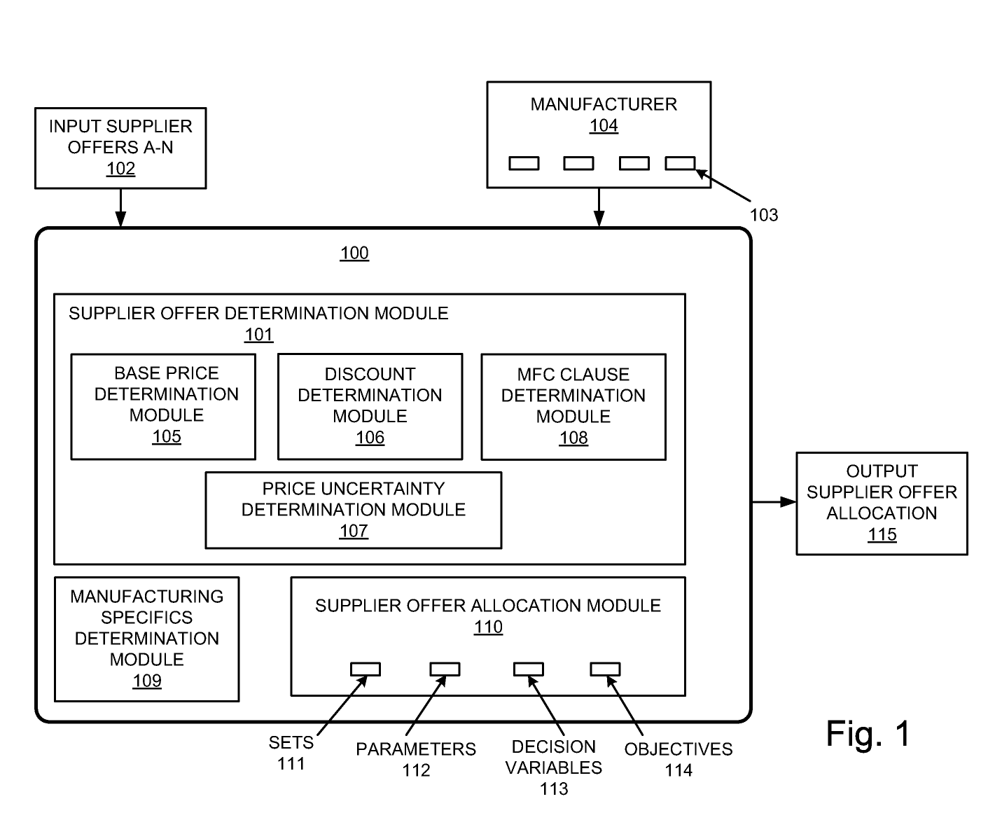

FIG. 1 illustrates an architecture of a supplier quantity selection apparatus 100, according to an example. Referring to FIG. 1, the apparatus 100 is depicted as including a supplier offer determination module 101 to receive a plurality of supplier offers 102 (i.e., supplier offers a-n) for one or more items 103 to be procured by a manufacturer 104. The supplier offer determination module 101 may include a base price determination module 105 to determine the base price for the items 103 offered by the suppliers associated with the supplier offers 102. Similarly, a discount determination module 106 is to determine a discount for the items 103 offered by the suppliers associated with the supplier offers 102. A price uncertainty determination module 107 is to determine whether the supplier offers 102 include price uncertainty, and if so, the specifics of the price uncertainty. A MFC clause determination module 108 is to determine whether the supplier offers 102 include one or more MFC clauses, and if so, the specifics of the MFC clause(s). Other aspects of the supplier offers 102 may be determined by the supplier offer determination module 101 as needed. A manufacturing specifics determination module 109 is to determine manufacturing specifics, such as, for example, a number and type of items needed, a number and type of items available in a manufacturer's inventory, and associated planning horizon and period information. The manufacturing specifics determination module 109 may also determine manufacturing constraints, such as, for example, inventory balance constraints, capacity constraints, discount quantity constraints, business constraints, split award constraints, etc., that are specific to the manufacturer 104. A supplier offer allocation module 110 is to evaluate the supplier offers 102 by analyzing, for example, information related to base price, discounts, price uncertainty, and MFC clauses using a stochastic multi-stage process. The supplier offer allocation module 110 may determine an allocation of all or part of each of the supplier offers to minimize, for example, purchase price of the items 103 based on the evaluation of the supplier offers. The supplier offer allocation module 110 may include sets 111, parameters 112, decision variables 113, and objectives 114, as described herein, for determining an allocation of all or part of each of the supplier offers 102. An allocation of a supplier offer 102 may thus include an allocation of the items 103 to a supplier based on the entire offer, parts of the offer, or none of the offer. The determined allocation of the supplier offers may be output at 115, for example, at a user interface.

The modules 101 and 105-110, and other components of the apparatus 100 that perform various other functions in the apparatus 100, may comprise machine readable instructions stored on a computer readable medium. In addition, or alternatively, the modules 101 and 105-110, and other components of the apparatus 100 may comprise hardware or a combination of machine readable instructions and hardware.

Implementation of the supplier quantity selection apparatus 100, and the aspects of price uncertainty and MFC terms are described with reference to an example of a manufacturer 104 that may need to procure an item 103 over a two-period horizon. For the item 103, demand in the first and second periods may be respectively denoted as δ₁ and δ₂. For a first offer 102, a supplier-a may charge μₐ per unit and offer a MFC indicating that if the manufacturer 104 procures 100m items 103 (m being a parameter indicating the minimum fraction of demand that the manufacturer 104 should buy in order to obtain MFC status) of the first period δ₁ demand for the items 103 from supplier-a, price will be reduced by πₐ per unit with probability γ, or otherwise remain constant with probability (1−γ). For a second offer 102, a supplier-b charges μ_{b} per unit and offers a volume discount indicating that if the manufacturer 104 procures a total of ρ of the items 103 in the two periods δ₁ and δ₂, price will be reduced by π_{b} per unit of the item 103. For the first and second offers 102:

δ₁₊δ₂≧ρ>(1−m)δ₁₊δ₂ Equation (1)

μ_{b}<μₐ<μ_{b}+πₐ Equation (2)

The expected cost Φ₀^{a} if the manufacturer 104 procures enough items from supplier-a to benefit from MFC may be represented as follows:

Φ₀^{a}=μₐmδ₁+μ_{b}(1−m)δ₁+γ(μₐ−πₐ)δ₂+(1−γ)μ_{b}δ₂ Equation (3)

The expected cost Φ^{b} if the manufacturer 104 procures enough items from supplier-b to benefit from a volume discount may be represented as follows:

Φ^{b}=(μ_{b}−π_{b})(δ₁−δ₂) Equation (4)

The manufacturer 104 may choose supplier-a's MFC status if (Φ₀^{a}<Φ^{b}) such that:

$$γ > {γ}_{0} = \frac{{π}_{b} ( {δ}_{1} + {δ}_{2} ) + ( {μ}_{a} - {μ}_{b} ) m {δ}_{1}}{( {π}_{b} + {μ}_{b} - {μ}_{a} ) {δ}_{2}} \qquad Equation ( 5 )$$

According to a certainty equivalent argument (i.e., ignoring uncertainty by using expected prices for the future), supplier-a's second period price may be represented as μₐ−γπₐ, and if the manufacturer 104 chooses to use MFC, the manufacturer's cost may be represented as:

Φ₁^{a}=μₐmδ₁+μ_{b}(1−m)δ₁+(μₐ−γπₐ)δ₂ Equation (6)

The manufacturer 104 may choose supplier-a's MFC term if (Φ₁^{a}<Φ^{b}), such that:

$$γ > {γ}_{1} = \frac{{π}_{b} ( {δ}_{1} + {δ}_{2} ) + ( {μ}_{a} - {μ}_{b} ) m {δ}_{1} + ( {μ}_{a} - {μ}_{b} ) {δ}_{2}}{{π}_{a} {δ}_{2}} \qquad Equation ( 7 )$$

This results in γ₀<γ₁. For γ₀<γ≦γ₁, an optimal decision for the manufacturer 104 would be to purchase enough items 103 to be eligible for supplier-a's MFC clause. However, a certainty equivalent approach (i.e., without taking price uncertainty and MFC into consideration) may lead to the manufacturer 104 opting for volume discount from supplier-b. Thus, a certainty equivalent approach may lead to suboptimal decisions.

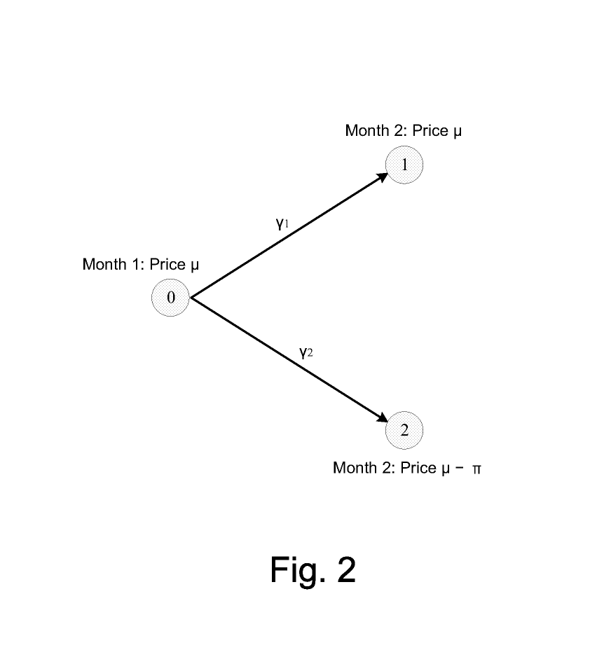

The supplier quantity selection apparatus 100 may thus account for price uncertainty, and use a stochastic approach for a scenario based mixed integer program (MIP). The MIP may use both continuous and integer variables to represent decisions and constraints. For example, referring to FIG. 2, a price for an item at month 1 may be set at μ. At month 2, the price may remain the same at μ (i.e., state 1) with a probability γ₁, or alternatively, may go down to μ−π (i.e., state 2) with probability γ₁. Therefore, at month 2 and subsequently, the price may be in one of the two states 1 or 2, and additional states as needed. Thus, a discount rule r may be available at node 2 (if the supplier lowers its price to other manufacturers) contingent on a condition c that the total volume purchased in months τ_{c}={1} exceeds ρ_{c}. In this case, a discount k may provide a discount of π per unit for any item that is bought above θₖ=0 in months τₖ={2}, where a(1)=a(2)=0, τ(0)=1, τ(1)=τ(2)=2.

The foregoing aspects related to price uncertainty and MFC clauses in the supplier offers 102 related to the manufacturer 104 may be modeled and evaluated by the supplier offer allocation module 110 as follows. The supplier offer allocation module 110 may include the sets 111, the parameters 112, the decision variables 113, and the objectives 114, as described herein, for determining an allocation of all or part of each of the supplier offers 102. The supplier offer allocation module 110 may model the sets 111 as follows:

[symbol] : Set of items indexed by i

[symbol] : Set of suppliers indexed by j

[symbol] : Set of time periods indexed by t

[symbol] : Set of nodes indexed by s

[symbol] , [symbol] , [symbol] : Set of all, discount or lump sum rules indexed by r. [symbol] = [symbol] ∪

[symbol]

[symbol] : Set of discounts indexed by k

[symbol] : Set of conditions indexed by c

[symbol] : Set of suppliers that are qualified for item i. [symbol] ⊂

[symbol]

[symbol] : Set of conditions required for rule r. [symbol] ⊂

[symbol]

[symbol] : Set of discounts given by rule r. [symbol] ⊂

[symbol]

[symbol] : Set of time periods for which the condition c applies. [symbol] ⊂

[symbol]

[symbol] : Set of items for which the condition c applies. [symbol] ⊂

[symbol]

[symbol] : Set of time periods for which the discount k applies. [symbol] ⊂

[symbol]

[symbol] : Set of items for which the discount k applies. [symbol] ⊂

[symbol]

[symbol] , [symbol] , [symbol] : Set of all, discount or lump sum rules available at node s

Thus, the sets 111 may generally account for the items 103, suppliers associated with the supplier offers 102, time periods (e.g., time periods for a planning horizon), nodes (e.g., see FIG. 2), discounts, conditions, etc. The supplier offer allocation module 110 may model the parameters 112 as follows:

δᵢₜ: demand for item i in period t

ηᵢₜ: inventory holding cost for item i in period t

κᵢⱼₜ: capacity for item i of supplier j in period t

μᵢⱼₜ: unit price for item i of supplier j in period t

πₖ: discount per unit offered with discount k

ωᵣ: lump sum rebate offered by rule r

θₖ: quantity above which discount k is applied

ρ_{c}: minimum order quantity for condition c

Thus, the parameters 112 may generally account for demand for the item 103 in a period, inventory holding cost, capacity for the item 103 for a supplier in a period, unit price for the item 103, discount per unit of the item 103, lump sum rebate(s), quantity above which a discount is applied, and minimum order quantity for a condition. The supplier offer allocation module 110 may model the decision variables 113 as follows:

xᵢⱼₛ: order quantity for item i from supplier j at node s

Iᵢₛ: ending inventory for item i at node s

$${z}_{r}^{s} \text{:} \{ \begin{matrix}1 & if rule r is taken at node s \\ 0 & otherwise\end{matrix}$$

yₖ^{s}: total number of units that are discounted with discount k

Thus, the decision variables 113 may generally account for order quantity for the item 103 from a specific supplier at a node (see FIG. 2), ending inventory for the item 103 at a node, and total number of units for the item 103 that are discounted.

Based on the sets 111, the parameters 112, and the decision variables 113, the supplier offer allocation module 110 may include the objective 114, for example, to minimize the expected purchasing and inventory holding costs for the item 103 for the manufacturer 104. In order to determine the expected total cost of purchasing all the items, the supplier offer allocation module 110 may determine the total cost over all the states (i.e., nodes), and determine an expectation defined as a mathematical term over all the states as follows:

$$min {\sum }_{s ∈ V}^{ } {γ}_{s} ( \begin{matrix}{\sum }_{i ∈ 𝒥}^{ } {\sum }_{j ∈ {N}_{i}}^{ } {μ}_{i j τ ( s )} {x}_{ijs} + \\ {\sum }_{i ∈ 𝒥}^{ } {η}_{i τ ( s )} {I}_{is} - {\sum }_{r ∈ {D}^{s}}^{ } {\sum }_{k ∈ {X}_{τ}}^{ } {π}_{k} {y}_{k}^{s} - {\sum }_{r ∈ {L}^{s}}^{ } {ω}_{r} {z}_{r}^{s}\end{matrix} ) \qquad Equation ( 8 )$$

The set of all possible outcomes of uncertain parameters may be represented by a state set and each realization of the parameter may be considered to correspond to a state. For example, price of an item may have many levels and each level may be represented with a state. Generally, the inputs to Equation (8) may include the price offers from each supplier associated with the supplier offers 102, the discounts and markups from each supplier, and the inventory holding and backorder costs for each item 103 and state. For Equation (8), γₛ may represent the probability that scenario s will materialize.

The supplier offer allocation module 110 may be used to incorporate different types of constraints. For example, inventory balance constraints may be determined as follows:

$$s . t . {I}_{is} = {I}_{is ( s )} + {\sum }_{j ∈ {N}_{i}}^{ } {x}_{ijs} - {δ}_{i τ ( s ) } ∀ i ∈ 𝒥 , s ∈ v \qquad Equation ( 9 )$$

For example, for Equation (9), the inventory balance constraints may be used to confirm that the amount of inventory left from a previous period, plus the amount purchased for a current period, is equal to the period demand plus the inventory for the current period for each item and each state. The inventory left may be negative if backorders are allowed using a backorder variable with an inventory variable. For Equation (9), lᵢₐ₍ₛ₎ may represent inventory left from a previous period, were a(s) represents an ancestor state of state s.

The supplier offer allocation module 110 may use capacity constraints to verify that for each item 103, the purchased quantity from a supplier associated with one of the supplier offers 102 does not exceed the production capacity of the supplier. Capacity constraints may be determined as follows:

xᵢⱼₛ≦k_{ijτ(s)} ∀iετ,jεNᵢ,sεV Equation (10)

For the supplier offer allocation module 110, each discount may include one or more condition constraints which can span over many periods and states, and over arbitrary items. Condition constraints may be determined as follows:

$$\text{?} \text{?} {x}_{{ij}_{τ} \hat{s}} \geq {ρ}_{c} {z}_{τ}^{s} ∀ s ∈ V , r ∈ {R}^{s} , c ∈ {C}_{r} \\ \text{?} \text{indicates text missing or illegible when filed} \qquad Equation ( 11 )$$

For Equation (11), a condition may be a minimum or maximum purchase quantity, spend amount, or a percentage of total available market for the item 103. Constraints may also verify that for a discount to be active, all the corresponding conditions are to be met.

For the supplier offer allocation module 110, discount quantity constraints may determine whether a discount is active, the item quantity that benefits from discounts for each discount offer, each item in the discount offer, and the corresponding states. Discount quantity constraints may be determined as follows:

$${y}_{k}^{s} \leq {\sum }_{i ∈ {𝒥}_{k}}^{ } \text{?} {x}_{{ij}_{{r}^{\hat{s}}}} - {θ}_{k} {z}_{r}^{s} ∀ s ∈ V , r ∈ {D}^{s} , k ∈ {K}_{r} \\ \text{?} \text{indicates text missing or illegible when filed} \qquad Equation ( 12 )$$

The discounts may be either total quantity discounts which apply to all the items in the discount offer, or incremental discounts which apply to the items more than a certain quantity. Similar to discount constraints, constraints for markups may increase the purchase price if certain conditions are met. Constraints may also check that the discount quantities never exceed the purchase quantities for each item and state. Constraints may also be used to model mutually exclusive discount offers so that one of the discounts will be active.

The supplier offer allocation module 110 may also incorporate different types of business constraints to meet various business needs. For example, linear offer rule constraints may allow the user to define minimum or maximum purchase quantities over arbitrary items and states for arbitrary suppliers. The supplier offer allocation module 110 may use winner constraints to limit the number of suppliers a particular item group is awarded to. For example, in order to minimize the risk of supply shortage, a restriction may be incorporated to purchase every item from one supplier.

The supplier offer allocation module 110 may use split award constraints, where a certain amount or purchase percentage of arbitrary item groups for arbitrary states may be assigned to different brackets, forcing an optimal solution to select among the assigned brackets. For example, a manufacturer 104 may be forced to purchase a certain percentage of the items 103 from one supplier, and the rest from a second supplier. The supplier offer allocation module 110 may determine which two suppliers to purchase from.

For the supplier offer allocation module 110, constraints may also be used to confirm that each variable is non-negative. For example, non-negativity constraints may be used to confirm that none of the variables for the supplier offer allocation module 110 take negative values to avoid erroneous results (e.g., purchase of negative quantities).

xᵢⱼₛ≧0 ∀iε [symbol] ,jε [symbol] ,sε [symbol] Equation (14)

Iᵢₛ≧0 ∀iε [symbol] ,sε [symbol] Equation (15)

zᵣ^{s}ε{0,1} ∀sε [symbol] , [symbol] ε [symbol] Equation (16)

yₖ^{s}≧0 ∀sε [symbol] ,rε [symbol] ,kε [symbol] Equation (17)

The supplier offer allocation module 110 discussed with respect to Equations (8)-(17) may thus model unit discounts and incremental discounts including, for example, discounts with multiple conditions, and/or separation of items for which conditions and discounts are applied. The supplier offer allocation module 110 may also model supplier offers with MFC clauses, and supplier offers with meet the competition clauses (MCC). The supplier offer allocation module 110 may further model multiple periods including, for example, inventory decisions, and/or separation of periods for which the conditions required and the discounts are applied. The supplier offer allocation module 110 may model offers with uncertain elements, including, for example, MFC and/or MCC, spot price uncertainty, and/or future trade deals.

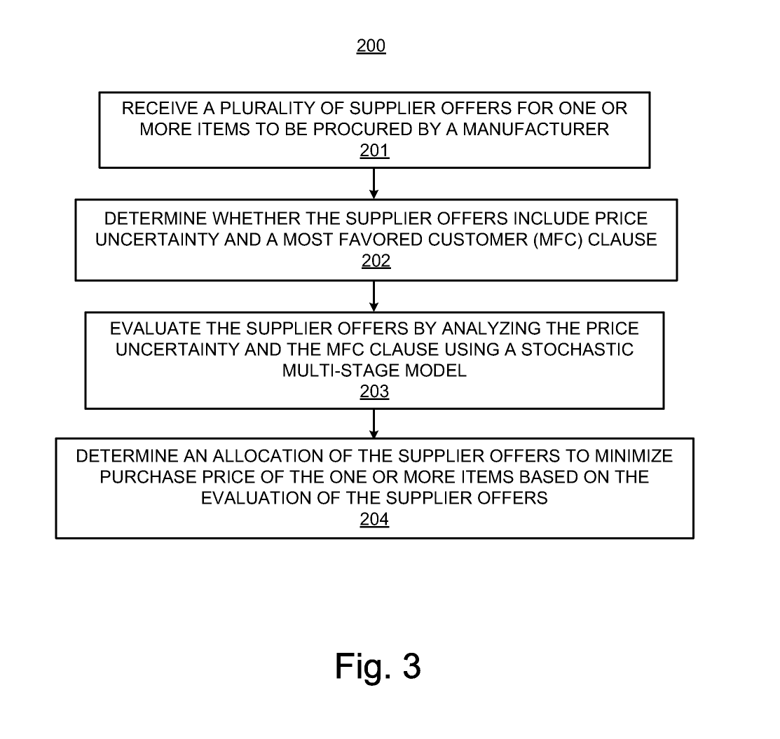

FIG. 3 illustrates a flowchart of a method 200 for supplier quantity selection, corresponding to the example of the supplier quantity selection apparatus 100 whose construction is described in detail above. The method 200 may be implemented on the supplier quantity selection apparatus 100 with reference to FIG. 1 by way of example and not limitation. The method 200 may be practiced in other apparatus.

Referring to FIG. 3, for the method 200, at block 201, a plurality of supplier offers for one or more items to be procured by a manufacturer may be received. For example, referring to FIG. 1, the supplier offer determination module 101 may receive a plurality of supplier offers 102 (i.e., supplier offers a-n) for one or more items 103 to be procured by the manufacturer 104.

At block 202, a determination may be made whether the supplier offers include price uncertainty and a MFC clause. For example, referring to FIG. 1, the price uncertainty determination module 107 may determine whether the supplier offers 102 include price uncertainty, and if so, the specifics of the price uncertainty. Further, the MFC clause determination module 108 may determine whether the supplier offers 102 include one or more MFC clauses, and if so, the specifics of the MFC clause(s).

At block 203, based on the determination that the supplier offers include price uncertainty and the MFC clause, the supplier offers may be evaluated by analyzing the price uncertainty and the MFC clause using a stochastic multi-stage model. For example, referring to FIG. 1, the supplier offer allocation module 110 may evaluate the supplier offers 102 by analyzing, for example, information related to base price, discounts, price uncertainty, and MFC clauses using a stochastic multi-stage process. Evaluation of the supplier offers may include, for example, determining an expected total cost of purchasing the one or more items 103 by determining total cost of the one or more items 103 over all states that represent possible total costs of the one or more items 103. The evaluation may further include incorporating an inventory balance constraint to confirm that an amount of inventory of the one or more items 103 left from a previous period, plus an amount of inventory of the one or more items 103 purchased for a current period, is equal to a period demand for the one or more items 103, plus inventory for the current period for the one or more items 103 and for each state of the inventory of the one or more items 103. The evaluation may include incorporating a capacity constraint to verify that a purchased quantity of the one or more items 103 from a supplier does not exceed a production capacity of the supplier for the one or more items 103. The evaluation may further include incorporating a condition constraint based on a minimum or maximum of a purchase quantity of the one or more items 103, a spend amount for the one or more items 103, and/or a percentage of total available market for the one or more items 103. The evaluation may include incorporating a discount quantity constraint to determine whether a discount for the one or more items 103 is active, a quantity for the one or more items 103 that benefits from discounts for each discount offer, and/or each item in the discount offer. The evaluation may further include incorporating linear offer rule constraints to allow definition of minimum or maximum purchase quantities over arbitrary items and states for arbitrary suppliers. The evaluation may include incorporating winner constraints to limit a number of suppliers to which a particular item is allocated. The evaluation may also include incorporating split award constraints such that a certain amount of arbitrary item groups for arbitrary states are assigned to different suppliers.

At block 204, an allocation of all or part of each of the supplier offers may be determined to minimize purchase price of the one or more items based on the evaluation of the supplier offers. For example, referring to FIG. 1, the supplier offer allocation module 110 may determine an allocation of all or part of each of the supplier offers to minimize, for example, purchase price of the items 103 based on the evaluation of the supplier offers. The supplier offer allocation module 110 may also determine an allocation of all or part of each of the supplier offers to minimize, for example, inventory holding and procurement costs of the items 103 based on the evaluation of the supplier offers.

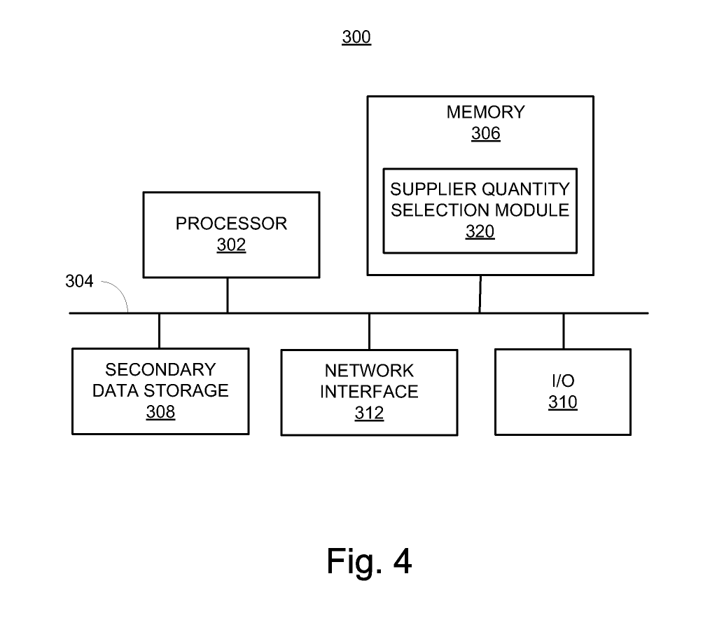

FIG. 4 shows a computer system 300 that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 302 that may implement or execute machine readable instructions performing some or all of the methods, functions and other processes described herein. Commands and data from the processor 302 are communicated over a communication bus 304. The computer system also includes a main memory 306, such as a random access memory (RAM), where the machine readable instructions and data for the processor 302 may reside during runtime, and a secondary data storage 308, which may be non-volatile and stores machine readable instructions and data. The memory and data storage are examples of computer readable mediums. The memory 306 may include a supplier quantity selection module 320 including machine readable instructions residing in the memory 306 during runtime and executed by the processor 302. The supplier quantity selection module 320 may include the modules 101 and 105-110 of the apparatus shown in FIG. 1.

The computer system may include an I/O device 310, such as a keyboard, a mouse, a display, etc. The computer system may include a network interface 312 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for supplier quantity selection, the method comprising:
receiving a plurality of supplier offers for at least one item to be procured by a manufacturer;
determining whether the supplier offers include price uncertainty and a most favored customer (MFC) clause;
based on the determination that the supplier offers include price uncertainty and the MFC clause, evaluating the supplier offers by analyzing the price uncertainty and the MFC clause using a stochastic multi-stage model; and
determining, by a processor, an allocation of all or part of each of the supplier offers to minimize purchase price of the at least one item based on the evaluation of the supplier offers.

2. The method of claim 1, wherein the at least one item is to be procured by the manufacturer over a planning horizon including multiple periods.

3. The method of claim 1, further comprising:
determining the allocation of all or part of each of the supplier offers to minimize inventory holding and procurement costs of the at least one item based on the evaluation of the supplier offers.

4. The method of claim 1, wherein evaluating the supplier offers by analyzing the price uncertainty and the MFC clause using the stochastic multi-stage model further comprises:
determining an expected total cost of purchasing the at least one item by determining total cost of the at least one item over all states that represent possible total costs of the at least one item.

5. The method of claim 1, wherein evaluating the supplier offers by analyzing the price uncertainty and the MFC clause using the stochastic multi-stage model further comprises:
incorporating an inventory balance constraint to confirm that an amount of inventory of the at least one item left from a previous period, plus an amount of inventory of the at least one item purchased for a current period, is equal to a period demand for the at least one item, plus inventory for the current period for the at least one item and for each state of the inventory of the at least one item.

6. The method of claim 1, wherein evaluating the supplier offers by analyzing the price uncertainty and the MFC clause using the stochastic multi-stage model further comprises:
incorporating a capacity constraint to verify that a purchased quantity of the at least one item from a supplier does not exceed a production capacity of the supplier for the at least one item.

7. The method of claim 1, wherein evaluating the supplier offers by analyzing the price uncertainty and the MFC clause using the stochastic multi-stage model further comprises:
incorporating a condition constraint based on a minimum or maximum of at least one of:
a purchase quantity of the at least one item,
a spend amount for the at least one item, and
a percentage of total available market for the at least one item.

8. The method of claim 1, wherein evaluating the supplier offers by analyzing the price uncertainty and the MFC clause using the stochastic multi-stage model further comprises:
incorporating a discount quantity constraint to determine at least one of:
whether a discount for the at least one item is active,
a quantity for the at least one item that benefits from discounts for each discount offer, and
each item in the discount offer.

9. The method of claim 1, wherein evaluating the supplier offers by analyzing the price uncertainty and the MFC clause using the stochastic multi-stage model further comprises:
incorporating linear offer rule constraints to allow definition of minimum or maximum purchase quantities over arbitrary items and states for arbitrary suppliers.

10. The method of claim 1, wherein evaluating the supplier offers by analyzing the price uncertainty and the MFC clause using the stochastic multi-stage model further comprises:
incorporating winner constraints to limit a number of suppliers to which a particular item is allocated.

11. The method of claim 1, wherein evaluating the supplier offers by analyzing the price uncertainty and the MFC clause using the stochastic multi-stage model further comprises:
incorporating split award constraints such that a certain amount of arbitrary item groups for arbitrary states are assigned to different suppliers.

12. A supplier quantity selection apparatus comprising:
a memory storing machine readable instructions to:
receive a plurality of supplier offers for at least one item to be procured by a manufacturer;
determine whether the supplier offers include at least one of price uncertainty and a most favored customer (MFC) clause;
based on the determination that the supplier offers include at least one of the price uncertainty and the MFC clause, evaluate the supplier offers by analyzing the at least one of the price uncertainty and the MFC clause using a stochastic multi-stage model; and
determine an allocation of all or part of each of the supplier offers to minimize a factor associated with the at least one item based on the evaluation of the supplier offers; and
a processor to implement the machine readable instructions.

13. The supplier quantity selection apparatus of claim 12, wherein the factor includes at least one of purchase price of the at least one item, and inventory holding and procurement costs of the at least one item.

14. The supplier quantity selection apparatus of claim 12, wherein evaluating the supplier offers by analyzing the at least one of the price uncertainty and the MFC clause using the stochastic multi-stage model further comprises machine readable instructions to:
determine an expected total cost of purchasing the at least one item by determining total cost of the at least one item over all states that represent possible total costs of the at least one item.

15. A non-transitory computer readable medium having stored thereon machine readable instructions for supplier quantity selection, the machine readable instructions when executed cause a computer system to:
receive a plurality of supplier offers for at least one item to be procured by a manufacturer;
determine whether the supplier offers include at least one of price uncertainty and a most favored customer (MFC) clause;
based on the determination that the supplier offers include at least one of the price uncertainty and the MFC clause, evaluate the supplier offers by analyzing the at least one of the price uncertainty and the MFC clause using a stochastic multi-stage model; and
determine, by a processor, an allocation of all or part of each of the supplier offers to minimize at least one of purchase price of the at least one item, and inventory holding and procurement costs of the at least one item, based on the evaluation of the supplier offers.
